(19) United States
(12) Patent Application Publication
(10) Pub. No.: US 2007/0014566 A1
(43) Pub. Date: Jan. 18, 2007

(54) Lens drive apparatus

(76) Inventors: Takashi Sobajima, Nagano (JP); Takeshi Sue, Nagano (JP); Noboru Otsuki, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/455,383

(22) Filed: Jun. 19, 2006

(30) Foreign Application Priority Data
Jun. 17, 2005 (JP) 2005-177079
May 22, 2006 (JP) 2006-141094

(51) Int. Cl. G03B 35/00

(52) U.S. Cl. 396/330

(57) ABSTRACT

A lens drive apparatus provides a moving lenticular body equipped with a lens. A driving mechanism is used to move the moving lenticular body in an axis direction of the lens. A fixed body supports the moving lenticular body so as to make it movable in an optical axis direction. A contact surface is formed in either the moving lenticular body or the fixed body so that the moving lenticular body contacts the contact surface to control the moving range of the lens drive apparatus in the optical axis direction.

### CROSS REFERENCE TO RELATED APPLICATIONS

This application claims priority to Japanese Application No. 2005-177079 filed on Jul. 17, 2005 and Japanese Application No. 2006-141094 filed on May 22, 2006.

### FIELD OF THE INVENTION

The present invention relates to a lens drive apparatus which moves a lens in an optical axis direction to form the image of a subject.

### BACKGROUND OF THE INVENTION

In recent years, camera-attached cellular phones have more advanced functions than ever before. For example, some have a macro photographing function to take pictures of subjects positioned closely at the camera lens. In the case of close-up photographing, the camera lens must be placed at a position slightly closer to the subject side than the position of the lens during ordinary photographing. Consequently, this type of cellular phone with a camera is equipped with a driving mechanism to move and drive the lens in an optical axis direction to form the image of a subject.

FIG. 8 is a cross-sectional perspective view showing the internal structure of conventional lens drive apparatus 100.

In FIG. 8, conventional lens drive apparatus 100 mainly comprises moving lenticular body 110 equipped with lens 111 and drive magnet 112, and cylindrical drive coil 121 surrounding the outer periphery of drive magnet 112. Moving lenticular body 110 is displaced in the optical axis direction F utilizing a magnetic force generated between the two members [sic, drive coil 121 and drive magnet 112]. In addition, fixed body 120 that supports moving lenticular body 110 so as to make it movable in the optical axis direction F is constructed with drive coil 121, first spacer member 123, and second spacer member 125.

During ordinary photographing, moving lenticular body 110 is held in such a manner that rear end surface 114 of drive magnet 112 and front end surface 125a of second spacer member 125 contact each other by magnetic attraction generated between drive magnet 112 and second spacer member 125. On the other hand, during close-up photographing, moving lenticular body 110 is held in such a manner that front end surface 113 of drive magnet 112 and rear end surface 123a of first spacer member 123 contacts each other by magnetic attraction generated between drive magnet 112 and first spacer member 123. (See Japanese Patent Application Publication No. 2004-184779 (FIG. 1)).

Nevertheless, the method of holding moving lenticular body 110 in the state mentioned above has the following problem.

First, during ordinary photographing, rear end surface 114 and front end surface 125a come into contact with each other in their entirety; during close-up photographing, front end surface 113 and rear end surface 123a come into contact with each other in their entirety; this means that, if, for instance, if contact surfaces are not polished fully, there is a problem of having the tendency to rattle. Moreover, if the moving lenticular body rattles, collision noise or the like is generated; eventually, one may find the noise disturbing.

Furthermore, if it is difficult to position moving lenticular body 110 very precisely, eventually, the optimal distance between lens 111 and an image sensor (photo detector) will result in error. By extension, images will deteriorate.

The present invention is achieved by taking the above point into consideration. Its objective is to provide a lens drive apparatus which can resist rattling during ordinary photographing or close-shot photographing, and can provide images with stable quality.

### SUMMARY OF THE INVENTION

In order to solve the above problems, the present invention provides the following.

(1) A lens drive apparatus characterized in that it comprises a moving lenticular body equipped with a lens, a driving mechanism made to move said moving lenticular body in the axis direction of said lens, a fixed body which supports said moving lenticular body so as to make it movable in the optical axis direction, and a contact surface formed in either said moving lenticular body or said fixed body, wherein said moving lenticular body contacts said contact surface to control the moving range of said lens drive apparatus in the optical axis direction.

According to the present invention, a contact surface that controls the movement range of a moving lenticular body is formed in either the lens-equipped moving lenticular body or a fixed body that supports this moving lenticular body so as to make it movable in the optical axis direction of the lens. Therefore, the moving lenticular body and fixed body are allowed to contact each other on part of the surface (contact surface) of the front end surface or the rear end surface, but not on the entire surface of the front end surface or rear end surface.

Thus, as long as contact surfaces maintain a uniform flatness, the previously described rattling or generation of collision noise can be prevented. Moreover, the moving lenticular body can be secured and held at a position with high precision (and as many times as desired), rendering images with stable quality (e.g. clear images, and the like).

Here, the “contact surface” is the surface formed in either the moving lenticular body or the above-mentioned fixed body which can be present in any number, size, and shape. Moreover, the contact surface may be formed integral with the moving lenticular body or the fixed body, or may be formed separately.

The lens drive apparatus is characterized in that either said moving lenticular body or said fixed body is provided with three of said contact surfaces.

According to the present invention, the presence of three contact surfaces mentioned above efficiently prevents the lens drive apparatus from rattling or generating collision noise. More specifically, if two contact surfaces are provided at two points, the lens drive apparatus may be shaken in a direction perpendicular to the straight line passing through the two points. On the other hand, if four contact surfaces are provided, the lens drive apparatus may be shaken in the direction of diagonal lines passing through two of the four points. Providing five or more contact surfaces will increase the manufacturing time because more machining processes take more time. For this reason, providing three contact surfaces can prevent the lens drive apparatus from rattling or generating collision noise effectively.

The lens drive apparatus is further characterized in that, within the surface including said contact surface and facing either said moving lenticular body or said fixed body, the area ratio of said contact surface is smaller than the area ratio of the non-contact surface.

According to the present invention, since the area ratio of the contact surface mentioned above is smaller than that of the non-contact surface, even if particles, dust, or the like accumulates on the surface facing either the moving lenticular body or the above-mentioned fixed body, the probability of the particles or dust to accumulate on the contact surfaces becomes small. As a result, the above mentioned rattling or generation of collision noise can be prevented more reliably. Particularly, the fact that air flow generated by the movement of the moving lenticular body in the optical axis direction makes it more difficult for particles, dust, or the like to remain on the contact surfaces. Therefore, the above-mentioned rattling or generating of collision noise can be prevented more reliably.

The lens drive apparatus is also characterized in that, in the vicinity of said contact surface, a guide section is provided on either said moving lenticular body or said fixed body to guide said moving lenticular body to move in the optical axis direction.

According to the present invention, since a guide section is provided in the vicinity of the above mentioned contact surfaces to guide a moving lenticular body to be displaced in the optical axis direction, tilting and mutual abutment of moving lenticular body and the fixed body, as well as rattling or generation of the collision noise can be prevented. In addition, this guide section is provided on the area that is in the vicinity of part of the front end surface or the rear end surface (contact surface), not on the entire surface of either the front end surface or rear end surface. As a result, friction caused by the movement of the moving lenticular body can be reduced.

According to the present invention, by limiting the surface on which the moving lenticular body and the fixed body contact the contact surface, rattling or generation of collision noise can be prevented more reliably. Moreover, it enables the moving lenticular body to be held at a point with good precision, consequently providing images of stable quality.

In addition, this embodiment assumes the lens drive apparatus that is incorporated into the camera-attached cellular phone. However, the present invention is not limited to this. It can be incorporated into other electronic devices in addition to camera-attached cellular phones, for example, a PDA (Personal Digital Assistance), a digital camera, and the like.

### BRIEF DESCRIPTION OF THE DRAWINGS

FIG. 1 shows a cross section showing the whole lens drive apparatus assembly of an embodiment of the present invention.

FIG. 2 shows an exploded perspective view of the lens drive apparatus shown in FIG. 1.

FIG. 3 shows a plan view of the first case piece.

FIG. 4 shows a plan view of the second case piece.

FIG. 5 shows a perspective view showing the external construction of the lens barrel in the lens drive apparatus associated with another embodiment of the present invention.

FIG. 6 shows a cross section showing the mechanical construction of the lens drive apparatus associated with another embodiment of the present invention.

FIG. 7 shows an exploded perspective view of the lens drive apparatus shown in FIG. 6.

FIG. 8 shows a perspective view of a conventional lens drive apparatus.

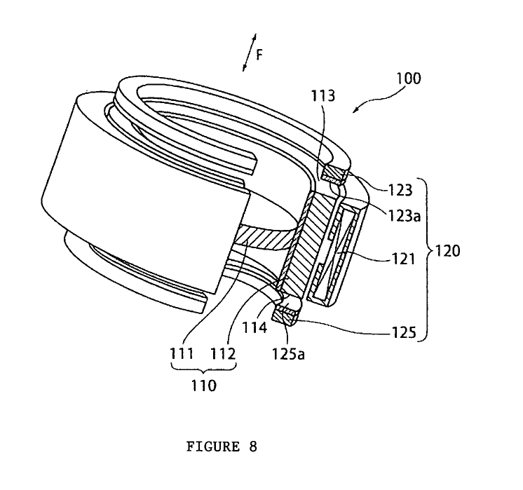

### DETAILED DESCRIPTION OF THE DRAWINGS

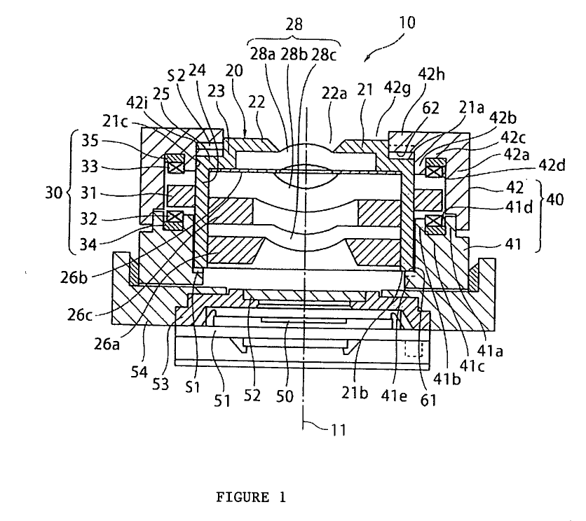

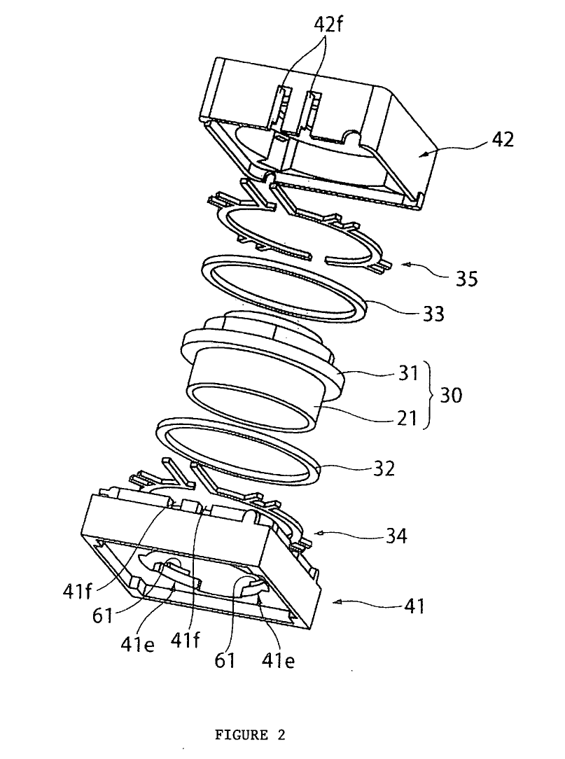

FIG. 1 is a cross section showing the overall construction of lens drive apparatus 10 of the embodiment of the present invention. FIG. 2 is an exploded perspective view of lens drive apparatus 10 shown in FIG. 1.

In FIG. 1 or 2, lens drive apparatus 10 mainly comprises moving lenticular body 20 equipped with camera lens 28 for photographing, driving mechanism 30 to displace moving lenticular body 20 in the direction of optical axis 11 of lens 28, case body 40 (part of the fixed body) to house moving lenticular body 20 and driving mechanism 30, image sensor 50 to form an image through lens 28, and circuit board 51 on which image sensor 50 is secured. In addition, CMOS (Complementary Metal Oxide Semiconductor) is adopted for image sensor 50 here.

Moving lenticular body 20 comprises lens 28 and cylindrical lens barrel 21 containing lens 28. Lens barrel 21 is made of a resin such as polycarbonate material. Circular entrance window 22a which is for taking the reflected light from the subject into lens 28 is formed at bottom section 22, which is positioned on the upper side of FIG. 1. Moreover, small diameter section 23 is formed on the outer periphery of lens barrel 21 on the upper side of FIG. 1 (the side of bottom section 22); large diameter section 24 which has a larger diameter than small diameter section 23 is formed on the lower side of FIG. 1. The boundary between large diameter section 24 and small diameter section 23 is provided with step 25.

Lens 28 arranged inside lens barrel 21 is made up of subject side-lens 28a, middle lens 28b, and camera body side-lens 28c, and these components are arranged in that order from the side of bottom section 22. Moreover, position fixing member 26a is fixed at the entrance of lens barrel 21 so as to hold down the camera body side-lens 28c. Subject side-lens 28a and middle lens 28b are spaced uniformly with spacer 26b which also serves as an iris. Middle lens 28b and camera body side-lens 28c are also spaced uniformly with spacer 26c. In addition, lens 28 and lens barrel 21 are separate members in this embodiment. However, the present invention is not limited to this. For instance, both of them may be formed by integrating the same members into one body Moreover, lens barrel 21 may be made of, for example, a metal, other than a resin.

Drive magnet 31, which is the first magnetic member, is fitted to the surface of the outer periphery of lens barrel 21 and is fixed thereto by an adhesive. This drive magnet 31 has a ring shape; it is magnetized so that the section surrounding the central hole becomes the N pole, and the outer periphery section of the overall drive magnet 31 becomes the S pole. Needless to say, the N pole and S pole may be reversed.

Case body 40 is constructed with two pieces: first case piece 41 and second case piece 42. In addition, case body 40 is made up with two pieces in this embodiment. However, it may be constructed with three or more pieces. Moreover, as for the material of case body 40, the use of a resin is common, and polycarbonate material is adopted in this embodiment. However, it may be made of, for example, a metal.

First case piece 41 is arranged on the lower side of FIG. 1, and second case piece 42 is arranged on the upper side (the bottom section 22 side) of FIG. 1. First case piece 41 is formed in a roughly cylindrical shape. It comprises outer barrel portion 41a protruding in the direction of optical axis 11 and inner barrel section 41b which contains lens barrel 21 inside the outer barrel section 41a. Moreover, outer barrel section 41a and inner barrel section 41b are joined at connection section 41c so as to provide a U-groove 41d constructed with outer barrel section 41a, inner barrel section 41b, and joint section 41c. In addition, in this embodiment, U-groove 41d has a U-shape in cross section. However, not to mention, it may have any shape in addition to a U shape.

Three first control sections 41e are formed in the direction of the periphery at roughly equal intervals in such a manner that they protrude toward the inside on the surface of the lower inner periphery of inner barrel section 41b. This first control section 41e controls the moving range of optical axis direction 11 of moving lenticular body 20. Notch 41f is provided on outer barrel section 41a such that a power supply member which supplies power to first drive coil 32 can be pulled to the outside (See FIG. 2).

In addition, although not particularly illustrated in this embodiment, an antirotation mechanism is provided in the lens barrel 21 and first case piece 41 lens barrel 21 to prevent lens barrel 21 from rotating as it is displaced in the direction of optical axis 11. Specifically, a convex section is provided on the outer periphery surface of lens barrel 21 while a concave section is provided on the inner periphery surface of first case piece 41 so that the concave section faces the convex section.

Second case piece 42 is formed in a roughly square cylindrical shape in the same manner as first case piece 41 is formed. As shown in FIG. 1, second case piece 42 is made up with opening 42g on the upper side (the side of bottom section 22), outer barrel section 42a protruding in the direction of optical axis 11, and cylindrical inner barrel section 42b containing lens barrel 21 inside outer barrel section 42a.

Outer barrel section 42a and inner barrel section 42b are connected together at joint section 42c, and a U-shaped groove 42d which has a cross-sectional U-shape has a ring shape formed by outer barrel section 42a, inner barrel section 42b, and joint section 42c.

On the inner wall surface of inner barrel section 42b, guide section 42i which slides on outer wall surface 21c on the upper end side of lens barrel 21 while abutting thereon is provided so as to guide lens barrel 21 in the direction of optical axis 11. Notch 42f is formed in outer barrel section 42a to pull out the power supply member which supplies electric power to second drive coil 33 (See FIG. 2).

An inner barrel section 42b is formed flange 42h protruding toward the inside. This flange 42h works as the second control section that controls the movement of movable lenticular body 20 in the optical axis direction within the ordinary photographing position where movable lenticular body 20 is displaced in FIG. 1 and the close-up photographing position where lens barrel 21 is moved upward.

At the bottom of U-grooves 41d and 42d is provided on each first case piece 41 and second case piece 42, first magnetic material 34 and second magnetic material 35 fixed [ON EACH OF THE CASE PIECES 41 AND 42] respectively. First drive coil 32 and second drive coil 33, each of which works as the second magnetic member, are fixed inside first magnetic material 34 and second magnetic material 35, respectively, so that each drive coil 32 and second drive coil 33 abuts the inner walls of inner barrel section 41b and inner barrel section 42b, respectively. In other words, first drive coil 32 and second drive coil 33 are housed in the previously described U-groove 41d and U-groove 42d, respectively.

First coil 32 and second drive coil 33 are arranged opposite each other in the direction of optical axis 11 so that drive magnet 31 is present between first coil 32 and second drive coil 33. First magnetic material 34 is arranged on the outside of first drive coil 32 in the direction of optical axis 11 and, at the same time, second magnetic material 35 is arranged on the outside of second drive coil 33 in the direction of optical axis 11. In other words, moving lenticular body 20 is housed in case body 40 (first case piece 41 and second case piece 42) in such a manner that drive magnet 31 is sandwiched between first drive coil 32 and second drive coil 33.

The distance between the opposed surfaces of first drive coil 32 and second drive coil 33 is made larger than the thickness of drive magnet 31 in the direction of optical axis 11, rendering a space between drive magnet 31 and first drive coil 32 or between drive magnet 31 and second drive coil 33 in the direction of optical axis 11. For this reason, drive magnet 31 can be displaced within the range of this space, and lens barrel 21 which is integrated into drive magnet 31 can also be displaced in the direction of optical axis 11 within the range of this space.

And when an electric current flows through either or both first drive coil 32 and second drive coil 33, drive magnet 31 is displaced in the direction of optical axis 11 within the range of the space mentioned above, which allows lens barrel 21 to slide along guide section 42i of second case piece 42 to be displaced in the direction of optical axis 11.

Furthermore, in this embodiment, driving mechanism 30 comprises drive magnet 31 as the first magnetic member, first drive coil 32 and second drive coil 33 as the second magnetic members, first magnetic material 34, and second magnetic material 35.

The magnetic flux from drive magnet 31 passes through first drive coil 32 or first magnetic material 34 to finally return to drive magnet 31 again. Similarly, the magnetic flux from drive magnet 31 passes through second drive coil 33 or second magnetic material 35 to finally return to drive magnet 31 again. Therefore, first drive coil 32 and second drive coil 33 are located in the magnetic field formed by drive magnet 31, and a magnetic circuit is formed by these members.

First magnetic material 34 and second magnetic material 35 are arranged, as described above, on the outside of each first drive coil 32 and second drive coil 33, respectively, in the direction of optical axis 11. Besides providing a back yoke when an electric current flows, the position of lens barrel 21 is held by the magnetic attraction caused by drive magnet 31 [and first magnetic material 34] or drive magnet 31 and second magnetic material 35. More specifically, when moving lenticular body 20 is in the ordinary photographing position shown in FIG. 1, even if an electric current does not flow through first drive coil 32 and second drive coil 33, lens barrel 21 can be held in the position by the magnetic attraction caused between drive magnet 31 and first magnetic material 34. On the other hand, when lens barrel 21 is moved upward to the close-up photographing position, even if an electric current does not flow through first drive coil 32 and second drive coil 33, similarly, lens barrel 21 can be held in the position by the magnetic attraction caused between drive magnet 31 and second magnetic material 35.

Arranged on the lower side of first case piece 41 in FIG. 1 in the direction of optical axis 11 are filter 52, rear end member 53 for housing image sensor 50 and circuit board 51 and the like, and image sensor case 54 which adjoins rear end member 53. Filter 52 cuts off a predetermined wavelength light which corresponds to the detection wave length of image sensor 50. Image sensor 50 is a CMOS (Complementary Metal Oxide Semiconductor) device, and sends the signal it detects to circuit board 51. The image signal based on the detected signal is sent to a control unit (e.g. a microcomputer etc.; not illustrated) through circuit board 51. In addition, as for image sensor 50, CCD, VMIS, and the like may be adopted in addition to CMOS. Moreover, image sensor 50 and the like have an orthogonal shape. In order to accommodate image sensor 50, image sensor case 57 also has an orthogonal shape. Also providing an orthogonal shape to first case piece 41 and second case piece 42 makes it possible to align moving lenticular body 20 and image sensor 50 easily. Moreover, first case piece 41 and second case piece 42 have roughly a prism shape, which also makes it possible to align them easily when they are mounted to a camera-attached cellular phone.

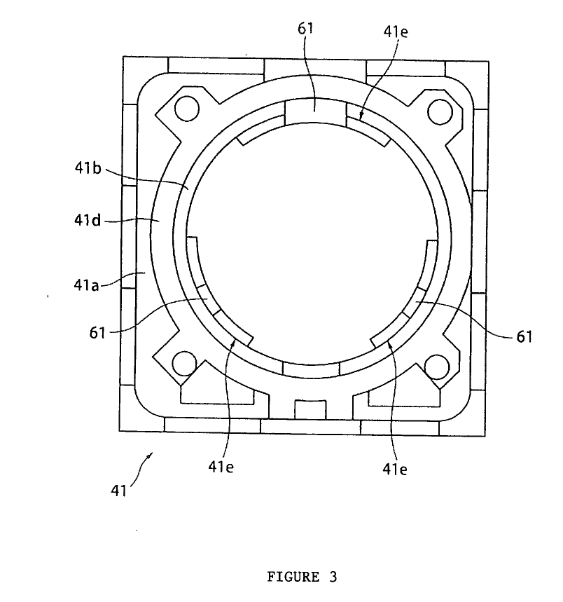

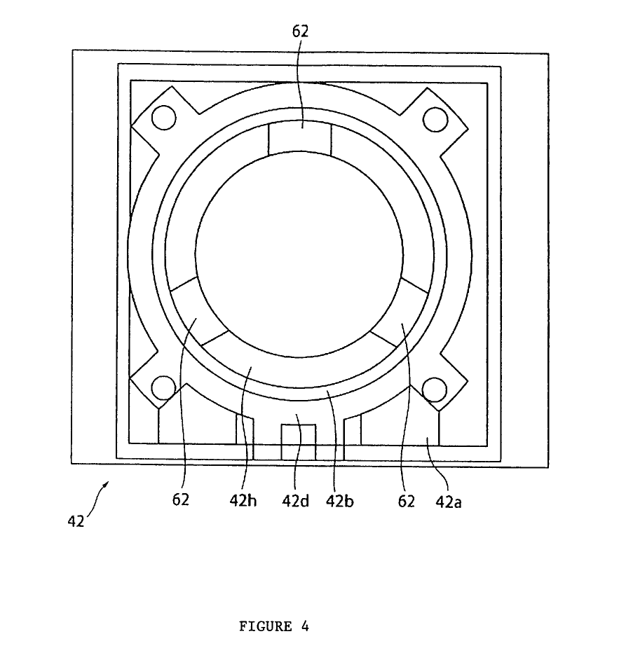

Next, contact surface 61 formed in case body 40 is described in detail with reference to FIGS. 3 and 4.

FIG. 3 is a plane view of first case piece 41.

In FIG. 3, three first control sections 41e are formed in first case piece 41. Contact surface 61 provided in each first control section 41e abuts lower surface 21b (FIG. 1) of lens barrel 21. This contact surface 61 is formed to protrude from first control section 41e in the direction of optical axis 11 (See FIG. 2). Moreover, in the ordinary photographing position, moving lenticular body 20 is held in such a manner that three contact surfaces 61 formed in first control sections 41e abut lower end surfaces 21b of lens barrel 21.

Here, any contact surface 61 that abuts contacting lower end surfaces 21b does not have a conical shape with a pointing tip but has a flat surface with a given area. If the tip of contact surface 61 is pointed (if the tip area is too small), it will wear down when it collides with the surface of lower end surface 21b of lens barrel 21, thus changing the contact position in the direction of optical axis 11. For this reason, any contact surface 61 has a size (area) so that it can maintain the degree of strength that resists wearing down caused by collision with lower end surface 21b of lens barrel 21.

Provided in first control section 41e is space S1 to prevent the area other than contact surfaces 61 from contacting lower end surface 21b of lens barrel 21 (See FIG. 1). In addition, the total area of three contact surfaces 61 is smaller than the area other than contact surfaces 61 (surface area constituting space S1). In other words, among all surfaces facing lower end surface 21b including contact surfaces 61, the area ratio of the contact surface is smaller than that of the non-contact surface. If the area of contact surfaces 61 is too large, the collision noise becomes loud. This point is considered and the area ratio of contact surfaces 61 is designed to suppress the collision noise to some degree.

When moving lenticular body 20 is in the ordinary photographing position in which lower end surfaces 21b of lens barrel 21 abut three contact surfaces 61 formed in first control section 41e, first drive coil 32 and drive magnet 31 will not collide with each other, thus preventing first drive coil 32 and drive magnet 31 from being damaged.

Furthermore, in order to secure the strength of contact surface 61, the length of first control section 41e is made longer than that of contact surface 61 in the peripheral direction. However, the present invention is not limited to this. For example, first control section 41e may have the same length and same shape as contact surfaces 61 as long as the length and shape allows the strength to remain unchanged.

Also in this embodiment, contact surfaces 61 are flat surfaces. However, the present invention does not limit them to the flat surface, and contact surfaces 61 may be curved surfaces. Moreover, each of the three contact surfaces 61 has the same area and shape. However, the present invention is not limited to this.

FIG. 4 is a plan view illustrating second case piece 42. Furthermore, in FIG. 4, second case piece 42 is viewed from the lower side of FIGS. 1 and 2.

In FIG. 4, three contact surfaces are formed at roughly even intervals in second control section 42h which is a circular flange in second case piece 42 so as to project in the direction of optical axis 11. In addition, when moving lenticular body 20 is in the close-up photographing position mentioned above, upper end surface 21a (See FIG. 1) of lens barrel 21 abuts contact surfaces 62 formed in second control section 42h at three points.

Three contact surfaces 62 are designed in the same manner as they were designed for contact surfaces 61 formed in first case piece 41 mentioned above, and their detailed descriptions are omitted here. Moreover, space S2 is formed in second control section 42h so that sections other than contact surfaces 62 do not abut on upper end surfaces 21a of lens barrel 21 (refer to FIG. 1). Moreover, the total area of three contact surfaces 61 is smaller than the area of sections other than contact surface 61 (the area of the surfaces constituting space S2).

When moving lenticular body 20 is in the close-up photographing position in which upper end surface 21a of lens barrel 21 abuts three contact surfaces 62 formed in second control section 42h, second drive coil 33 and drive magnet 31 are made so as not to collide against each other. Hence, damage of second drive coil 33 and drive magnet 31 can be prevented.

Next, operation of lens drive apparatus 10 is described in detail herein with reference to FIGS. 1-4.

When moving lenticular body 20 is in the ordinary photographing position as shown in FIG. 1, changing a given switch (not illustrated) allows an electric current to flow. Based on this electric current and drive magnet 31, an electromagnetic force is generated in the direction in which drive magnet 31 is pushed forward. Then, this electromagnetic force causes drive magnet 31 together with lens barrel 21 to be displaced forward (the side of bottom section 22).

In addition, as mentioned above, the amount of movement of lens barrel 21 is within the range of space provided between drive magnet 31 and first drive coil 32. Moreover, Fleming's left hand rule gives the directions of forces working on the current carrying object when a line current flows through a magnetic field. In this embodiment, however, since both first drive coil 32 and second drive coil 33 are stationary, a force will act on drive magnet 31 as a reaction to the above-mentioned rule.

If moving lenticular body 20 moves forward, and lens barrel 21 collides with three contact surfaces 62 formed in second regulation section 42h of second case piece 42, moving lenticular body [20] stops moving. In other words, forward movement is blocked by collision. At this time, moving lenticular body 20 is in the close-up photographing position.

When moving lenticular body 20 is in the close-up photographing position, even if an electric current is not flowing through first drive coil 32 and second drive coil 33, lens 28 is held by magnetic attraction generated between drive magnet 31 and second magnetic material 35. Thus, in the close-up photographing position, upper end surface 21a of lens barrel 21 can abut three contact surfaces 62, and can be fixed as many times as required with high precision. In addition, a minute space is formed between second drive coil 33 and drive magnet 31. This space prevents second drive coil 33 and drive magnet 31 from collision and damage. Moreover, although an electric current flows through both first drive coil 32 and second drive coil 33 here, an electric current may flow through, for example, only one of them.

Next, to change the position of moving lenticular body 20 from the close-up photographing position to the ordinary photographing position, one should change the switch to the ordinary photographing position. By doing so, an electric current flows through first drive coil 32 and second drive coil 33 in a direction which is opposite to the above-mentioned current flow, and an electromagnetic force works in the direction in which drive magnet 31 is pulled backward (the lower side of FIG. 1). As a result, moving lenticular body 20 and drive magnet 31 together are displaced backward.

Lower end surface 21b of lens barrel 21 moved backward collides with three contact surfaces 61 formed in first control section 41e of first case piece 41, and blocks backward movement. At this time, moving lenticular body 20 is in the ordinary photographing position.

When moving lenticular body 20 is in the ordinary photographing position, even if an electric current is not flowing through first drive coil 32 and second drive coil 33, lens 28 can be held by the magnetic attraction generated between drive magnet 31 and first magnetic material 34. As such, in the ordinary photographing position, lower end surface 21b of lens barrel 21 is made to contact three contact surfaces 61 to fix lens barrel 21 with precision as many times as possible. In addition, a minute space is formed between first drive coil 32 and drive magnet 31. This space prevents first drive coil 32 and drive magnet 31 from collision and damage. Moreover, here, although an electric current flows through both first drive coil 32 and second drive coil 33 at the same time. However, an electric current may flow through, for example, only one of them.

As described above, lens drive apparatus 10 associated with this embodiment comprises three contact surfaces 61 formed in first case piece 41 and three contact surfaces 62 formed in second case piece 42. The moving range of moving lenticular body 20 is controlled by contact surfaces 61 or contact surfaces 62 in the direction of optical axis 11. Therefore, as long as the flatness of contact surfaces 61 and 62 can be unchanged, rattling or generation of collision noise can be prevented. Additionally, moving lenticular body 20 is fixed and held in a position with good precision, eventually producing images of stable quality.

The ratio of the total area of three contact surfaces 61 formed in first case piece 41 is made smaller than the ratio of the area other than three contact surfaces 61. Similarly, the ratio of the total area of three contact surfaces 62 formed in second case piece 42 is made smaller than the ratio of the area other than three contact surfaces 62. Therefore, even if there is accumulation of particles, dust, and the like on the surfaces, the probability of their accumulation on contact surfaces 61 or contact surfaces 62 is low. By extension, rattling caused by accumulation of particles, dust, and the like can be prevented.

Furthermore, even if particles, dust, and the like accumulate on contact surfaces, since the ratio of the area that abuts three contact surfaces 61 or contact surfaces 62 is small, the adverse effects from the accumulation can be minimized. In addition, since particles and dust are blown away by the air flow generated by the movement of moving lenticular body 20, the possibility of leaving particles and dust on contact surfaces 61 or contact surfaces 62 can be reduced. As a result, the probability of accumulating particles, dust, and the like on contact surfaces 61 or 62 can be reduced.

Guide section 42i which contactingly slides along outer wall surface 21C on the upper end side of lens barrel 21a is provided in the vicinity of three contact surfaces 61 formed in second case piece 42 so as to guide the displacement of lens barrel 21 in the direction of optical axis 11. In this way, rattling can be prevented. By extension, generation of the collision noise caused by rattling can be prevented.

Since each of the three contact surfaces 61 or 62 has an area that does is not susceptible to wearing down, even if moving lenticular body 20 moves and collides with it repeatedly, generation of worn dust can be suppressed. Therefore, generating accuracy variations in positioning in the direction of optical axis 11 can be prevented. By extension, images of stable quality can be obtained.

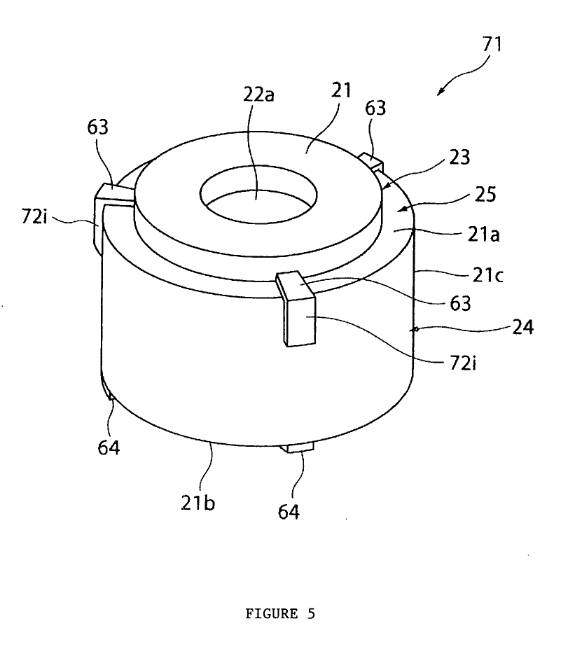

FIG. 5 is a perspective view showing the external appearance and construction of lens barrel 71 in the lens drive apparatus associated with another embodiment of the present invention. In addition, the same symbols are used for the same components used for lens barrel 21 shown in FIG. 1.

As shown in FIG. 5, in lens barrel 71, three contact surfaces 63 which contact in the close-up photographing position are provided at roughly equal intervals so as to protrude from upper end surface 21a. Like the previously described contact surfaces 61 and contact surfaces 62, contact surfaces 63 are designed to have a degree of strength that does not cause contact surfaces 63 to wear upon collision. Moreover, like contact surfaces 63, three contact surfaces 64 which contact the ordinary photographing position are provided at roughly equal intervals in lower end surface 21b so as to protrude. Like the previously described contact surfaces 61 or contact surfaces 62, these contact surfaces 64 are designed to have a degree of strength that does not wear down contact surfaces 64 upon collision.

Additionally, in lens barrel 71, three guide sections 72i protruding from outer wall 21c are formed at the same positions as three contact surfaces 63 in peripheral direction. In other words, these guide sections 72i slide on the inner surface of inner barrel section 42b of second case piece 42 so that lens barrel 71 is displaced in the direction of optical axis [11]. Furthermore, guide sections 72i are provided only at three points on the periphery, not on the entire periphery. As a result, the surface area subjected to sliding during the movement of lens barrel 71 in the direction of optical axis 11 is reduced, and friction caused by sliding is also reduced.

As described above, in lens drive apparatus 10 shown in FIGS. 1-4, three contact surfaces 61 or 62 were formed on the side of moving lenticular body 40. However, they may be formed on the side of case body 20 as shown in FIG. 5. Moreover, both types of contact surfaces, one type that contacts in the ordinary photographing position and the other type that contacts in the close-up photographing position, may be formed on the either side of case body 40 or moving lenticular body 20. Alternatively, one type of contact surface may be formed on the side of case body 40 while the other type of contact surface may be formed on the side of moving lenticular body 20.

Moreover, in FIGS. 1-5, the present invention is applied to the lens drive apparatus of the type in which moving lenticular body 20 is displaced by first drive coil 32, second drive coil 33, and drive magnet 31. However, the present invention is not limited to this. It may be applied to, for example, the lens drive apparatus of the type in which moving lenticular body 20 is displaced by a stepping motor and the like.

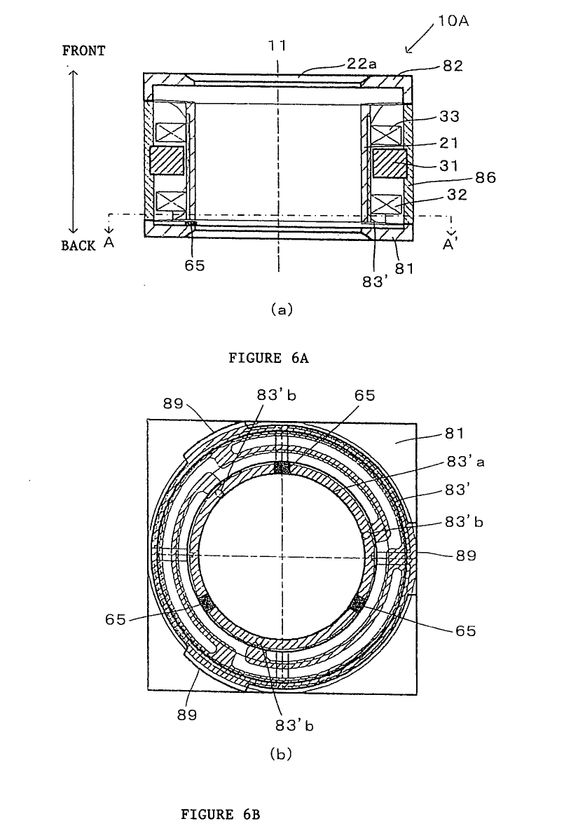

FIG. 6 is a cross section showing the mechanical construction of lens drive apparatus 10A associated with another embodiment of the present invention. More specifically, FIG. 6(a) is a cross section of lens drive apparatus 10A that is cut in the direction of optical axis 11 of the lens. FIG. 6(b) is a plan cross section when lens drive apparatus 10A as illustrated in the cross section of FIG. 6(a) is cut along A-A′ chain line. Moreover, in FIG. 6 (a), for convenience of description, the top is the front side close to the subject; the bottom is the rear side close to the camera body.

In FIG. 6, lens drive apparatus 10A mainly comprises second case piece 82 which is equivalent to a part of the fixed body, and lens barrel 21 which is equivalent to a part of moving lenticular body [20]. A roughly cylindrical barrel (not illustrated in FIG. 6. See FIG. 1) having optical axis 11 in its center is attached inside lens barrel 21. And multiple lenses (for example, lens 28a on the subject side, middle lens 28b, and lens 28c on the camera body side, and the like shown in FIG. 1) are combined inside the barrel.

Second case piece 82 and first case piece 81 can be interlocked and these components are used to secure cylindrical yoke 86. Ring-shaped drive magnet 31 is fastened to the surface of the inner periphery of this yoke 86.

At a point on the outer periphery of lens barrel 21 closer to the front side than drive magnet 31, second drive coil 33 is arranged opposite to drive magnet 31, and first drive coil 32 is arranged so that drive magnet 31 is present in the direction of optical axis 11 due to the relationship with this second drive coil 33. Moreover, second drive coil 33 and first drive coil 32 which are fastened to lens barrel 21 are able to perform a relative displacement in the direction of optical axis 11 with respect to yoke 86.

The magnetic flux from the N pole of drive magnet 31 passes through, for example, lens barrel 21, first drive coil 32 (or second drive coil 33), and yoke 86, and returns to drive magnet 31 again. Therefore, a magnetic circuit (magnetic path) is formed by the members comprising first drive coil 32, second drive coil 33, yoke 86, and lens barrel 21. In this case, a magnetic material is preferably employed for the material of lens barrel 21.

Installed in the center of the front side of second case piece 82 is circular entrance window 22a which is for taking in the reflected light from the subject to lens 28.

Flat spring 83 and flat spring 83′ are installed in lens drive apparatus 10A to control the movement of lens barrel 21. Among them, flat spring 83′ is described in detail with reference to FIG. 6(b). In FIG. 6(b), flat spring 83′ attached to first case piece 81 is engaged with antirotation groove 89 formed in first case piece 81, thereby preventing flat spring 83′ from rotating.

Flat spring 83′ is a metal-made spring to supply an electric current; and the lower end surface of lens barrel 21 is mounted to innermost circumferential part 83′a. On the other hand, three contact surfaces 65 that contact the rear side (part) of flat spring 83′ are formed in first case piece 81. In addition, in FIG. 6(b), the points where contact surfaces 65 are present in circumferential part 83a of flat spring 83′ are painted black in the inward section of the figures.

These contact surfaces 65 substantially control the moving range of lens barrel 21 by abutting flat spring 83′. If lens barrel 21 is in the ordinary photographing position, circumferential part 83′a of flat spring 83′ abuts three contact surfaces 65.

Moreover, contact surfaces (not illustrated) are formed in second case piece 82 in the same manner as the first case pieces 81. In the close-up photographing position, flat spring 83 abuts three contact surfaces (not illustrated). Therefore, repeatability of precision positioning of moving lenticular body 20 can be improved.

Moreover, three terminals 83b are formed in circumferential part 83′ to supply an electric current to first drive coil 32 (See FIG. 6(b)). An electric current is supplied to second drive coil 33 via terminal 83′b, and it flows through first drive coil 32 via the terminal. In this way, it is possible to use flat spring 83 and flat spring 83′ for the wiring for energization of first drive coil 32 and second drive coil 33.

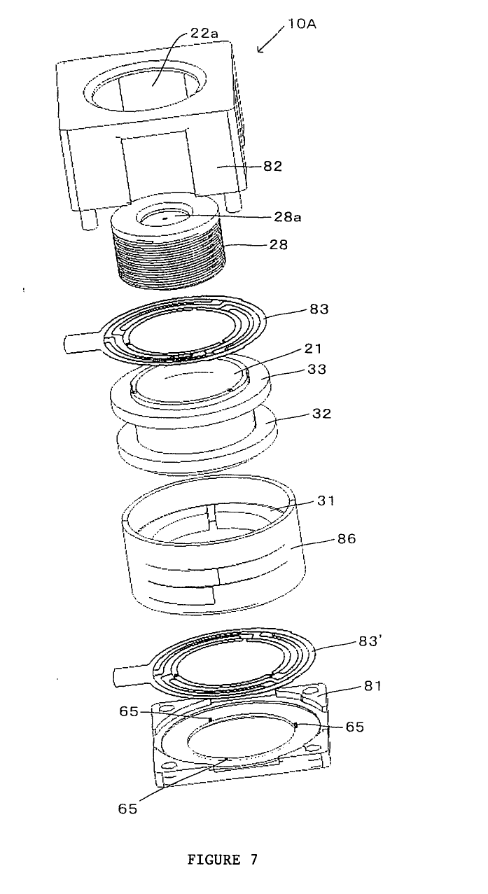

Next, the method of assembling lens drive apparatus 10A is described. FIG. 7 is an exploded perspective view of lens drive apparatus 10A illustrated in FIG. 6.

In FIG. 7, first, flat spring 83′ is attached to first case piece 81 so as to be engaged with antirotation groove 89 formed in first case piece 81. Next, drive magnet 31 and yoke 86 are divided into two pieces, and drive magnet 31 and yoke 86 are integrated (fastened) again so that drive magnet 31 is present between first drive coil 32 and second drive coil 33 that are fastened to the outer periphery of lens barrel 21. Then, yoke 86 inside which lens barrel 21 is incorporated is fixed to first case piece 81. At this time, the rear end surface of lens barrel 21 is mounted to the innermost side of circumferential part 83′a of flat spring 83′. Finally, flat spring 83 is mounted so that its innermost circumferential part abuts the front end surface of the lens barrel 21. Then, second case piece 82 is engaged with first case piece 81. As a result, when lens barrel 21 is in the ordinary photographing position, flat spring 83′ is present between the lower end surface of lens barrel 21 and contact surfaces 65; when the lens barrel 21 is in the close-up photographing position, flat spring 83 is present between the front end surface of lens barrel 21 and contact surfaces [65]. Thus, lens drive apparatus 10A as shown in FIG. 6(a) can be assembled. In addition, after assembly, lens 28 is screwed into lens barrel 21. Moreover, flat spring 83′ may be cut at the sections which abut contact surfaces 65. In this case, contact surfaces abut the lower end surface of lens barrel 21.

As described above, providing three contact surfaces in second case piece 81 which is equivalent to a part of the fixed body and second case piece 82 can suppress the collision noise caused by rattling which occurs when lens barrel 21 is displaced in the direction of optical axis 11. It can also enhance repeatability of precision positioning of lens barrel 21.

The lens drive apparatus associated with the present invention is useful in that it can prevent the lens drive apparatus from generating collision noise caused by rattling which occurs when a moving lenticular body is displaced; it can also reduce variations in precision holding of the moving lenticular body when the moving lenticular body is stopped at a desired position.

While the invention may be susceptible to various modifications and alternative forms, specific embodiments have been shown by way of example in the drawings. However, it should be understood that the invention is not intended to be limited to the particular forms disclosed. Rather, the invention is to cover all modifications, equivalents and alternatives falling within the spirit and scope of the invention as defined by the following appended claims.

We claim:

1. A lens drive apparatus comprising:
a moving lenticular body equipped with a lens;
a driving mechanism made to move said moving lenticular body in an axis direction of said lens,
a fixed body which supports said moving lenticular body so as to make it movable in an optical axis direction, and
a contact surface formed in either said moving lenticular body or said fixed body,
wherein said moving lenticular body contacts said contact surface to control the moving range of said lens drive apparatus in the optical axis direction.

2. The lens drive apparatus as set forth in claim 1, wherein said moving lenticular body or said fixed body comprise three said contact surfaces.

3. The lens drive apparatus as set forth in claim 2, wherein within the surface including said contact surface and facing either said moving lenticular body or said fixed body, an area ratio of said contact surface is smaller than the area ratio of the non-contact surface.

4. The lens drive apparatus as set forth in claim 2, wherein in the vicinity of said contact surface, a guide section being provided on either said moving lenticular body or said fixed body to guide said moving lenticular body to move in the optical axis direction.
